(19) United States
(12) Patent Application Publication
(10) Pub. No.: US 2022/0097344 A1
(43) Pub. Date: Mar. 31, 2022

(54) Plaster Boards and Methods for Making Them

(71) Applicant: CertainTeed Gypsum, Inc., Malvem, PA (US)

(72) Inventors: Aldo Glean, Framingham, MA (US); Zhiqiang Shi, Shrewsbury, MA (US); Xuejuan Xu, Northborough, MA (US); Ying Wang, Westborough, MA (US); Choung-Houng Lai, Acton, MA (US); James Dimitrakopoulos, Conshohocken, PA (US); Jia Liu, Shrewsbury, MA (US); John Langlois, Northborough, MA (US); Eric Dong, Northborough, MA (US); Gabriel Guyard, Northborough, MA (US); Mithun N. Kamath, Northborough, MA (US); Phillip Evans, Littleton, MA (US); Donald J. Beaudry, Needham, MA (US)

(21) Appl. No.: 17/487,846

(22) Filed: Sep. 28, 2021

Related U.S. Application Data
(60) Provisional application No. 63/084,347, filed on Sep. 28, 2020.

(51) Int. Cl. B32B 13/14; E04C 2/28; B32B 3/30; B32B 5/02; B32B 5/18; B32B 13/04

(52) U.S. Cl. CPC B32B 13/14; E04C 2/28; B32B 3/30; B32B 5/02; B32B 5/18; B32B 2260/021; B32B 2250/40; B32B 2262/101; B32B 2419/00; B32B 2307/54; B32B 2260/046; B32B 13/045

(57) ABSTRACT

The present disclosure relates to a plaster board comprising a first layer of hardened plaster material comprising a first surface and an opposed second surface, a second layer of hardened plaster material comprising a first surface and an opposed second surface, wherein the first surface of the second layer faces the first surface of the first layer, and a viscoelastic interlayer disposed between the first surface of the first layer and the first surface of the second layer, wherein the interlayer includes a score-and-snap element.

### CROSS-REFERENCE TO RELATED APPLICATIONS

This application claims the benefit of priority of U.S. Provisional Patent Application No. 63/084,347, filed Sep. 28, 2020, which is hereby incorporated herein by reference in its entirety.

### BACKGROUND OF THE DISCLOSURE

### 1. Field of the Disclosure

The present disclosure relates generally to plaster boards and methods for making plaster boards. The present disclosure relates more particularly to plaster boards having continuous layer of material (e.g., a polymer material such as a damping polymer) disposed within a body of plaster material.

### 2. Technical Background

Plaster boards, often called “sheet rock” or “drywall”, are typically used to construct walls within homes, businesses, or other buildings. Plaster boards are very often made of gypsum, but other materials, including lime and cement, are also used. A typical method for making a plaster board involves dispensing and spreading a plaster material (e.g., a slurry of gypsum in water) onto a paper sheet or fiberglass mat on a platform, and covering the plaster material with another paper sheet or fiberglass mat. This sandwiched structure is fed through rollers to provide a structure of a desired thickness, then allowed to cure to form a hardened plaster material disposed between the two sheets of paper or fiberglass. The plaster board may be cut into sections having predetermined lengths and widths that conform to accepted construction standards.

Soundproofing is becoming an ever-increasing concern for the construction industry, for example, for use in residences, hotels, schools and hospitals. Soundproofing is also desirable in the construction of theaters and music studios, to insulate noise made in those areas from surrounding rooms. Model building codes and design guidelines often specify minimum Sound Transmission Class values for wall structures within buildings. While a number of construction techniques have been used to address the problem of soundproofing, one especially desirable technique uses sound-damping plaster boards that can be used in place of conventional drywall boards various residential or commercial structures.

A sound-damping plaster board typically includes a damping layer having viscoelastic properties disposed between first and second layers of hardened plaster material. In some cases, the damping layer may be disposed between respective paper or fiberglass liners adhered to the first and second layers of hardened plaster material. The damping layer is typically more efficient at sound damping than the layers of hardened plaster material on either side of the damping layer.

Some sound-damping plaster boards may exhibit delamination due to ambient conditions such as temperature and humidity and/or tradeoffs that may exist between the sound-damping qualities and the adhesive strength of the viscoelastic polymer that holds the layers of hardened plaster material together. Some sound-dampening plaster boards may also exhibit delamination during installation, particularly when the board is scored and snapped.

Accordingly, what are needed are improved processes for making laminated plaster sound-damping plaster boards, and sound-damping plaster boards amenable for production by such processes with better product quality.

### SUMMARY OF THE DISCLOSURE

One aspect of the disclosure is a plaster board comprising:
a first layer of hardened plaster material comprising a first surface and an opposed second surface;
a second layer of hardened plaster material comprising a first surface and an opposed second surface, wherein the first surface of the second layer faces the first surface of the first layer; and
a viscoelastic interlayer disposed between the first surface of the first layer and the first surface of the second layer, wherein the interlayer includes a score-and-snap element.

In certain such embodiments, the score-and-snap element comprises at least one of an embossed surface, a layer of brittle material, a plurality of pores, or a binder miscible in the hardened plaster material.

Another aspect of the disclosure is a method of manufacturing a plaster board, the method comprising:
applying a first plaster slurry layer to a top surface of a first sheet material;
applying a damping sheet to a top surface of the first plaster slurry layer;
applying a second plaster slurry layer to a top surface of the damping sheet; and
applying a second sheet material to a top surface of the second plaster slurry layer.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure and together with the description serve to explain the principles and operation of the disclosure.

FIG. 1 is a set of three schematic views of a plaster board according to one embodiment of the disclosure.

FIG. 2 is a graph illustrating the elastic modulus of a viscoelastic interlayer of a plaster board and the thickness thereof.

FIG. 3 illustrates a method of manufacturing a plaster board according to one embodiment of the disclosure.

FIG. 4 is a schematic view of a plaster board according to an alternative embodiment of the disclosure.

FIGS. 5A and 5B are a schematic views of plaster boards according to alternative embodiments of the disclosure.

FIG. 6 is a schematic view of a damping sheet for use in a plaster board according to another alternative embodiment of the disclosure.

FIG. 7A illustrates an example embossing pattern on a damping sheet for use in a plaster board according to another alternative embodiment of the disclosure.

FIG. 7B illustrates an example embossing pattern on a damping sheet for use in a plaster board according to another alternative embodiment of the disclosure.

FIG. 7C illustrates an example embossing pattern on a damping sheet for use in a plaster board according to another alternative embodiment of the disclosure.

FIG. 7D illustrates an example embossing pattern on a damping sheet for use in a plaster board according to another alternative embodiment of the disclosure.

FIG. 7E illustrates an example embossing pattern on a damping sheet for use in a plaster board according to another alternative embodiment of the disclosure.

FIG. 7F illustrates an example embossing pattern on a damping sheet for use in a plaster board according to another alternative embodiment of the disclosure.

FIG. 7G illustrates an example embossing pattern on a damping sheet for use in a plaster board according to another alternative embodiment of the disclosure.

FIG. 8 illustrates a cross-section of an example damping sheet for use in a plaster board according to another alternative embodiment of the disclosure.

### DETAILED DESCRIPTION

The present inventors have noted disadvantages of existing processes for forming sound damping plaster boards or plaster boards having other sheets of material (i.e., having any desired function) disposed therein. Conventional plaster boards are formed between sheets of paper or fiberglass mat. While these can provide a surface on the plaster board suitable for painting and to protect the surface of the plaster board before and after installation, they can create difficulties in the lamination of such a plaster board to other materials. The present inventors note the disclosure of U.S. Patent Application Publication no. 2018/0171626 which describes an in-line process for forming sound-damping plaster boards. This publication is hereby incorporated herein by reference in its entirety for its teachings related to suitable materials for such boards and suitable methods for making such boards, which can generally be used in the practice of the structures and methods described herein. The present inventors note, however, that further improvement in score-and-snap performance is desirable in such boards.

Accordingly, one aspect of the disclosure is a plaster board having a first surface and an opposed second surface. The plaster board includes a body of hardened plaster material extending from the first surface of the plaster board to the second surface of the plaster board (i.e., including a first layer and a second layer), and one or more continuous layers of material (e.g., acoustic layers) disposed within the body (i.e., between the first layer and a second layer), each continuous layer having a first side and an opposed second side, the first side and second side of each continuous layer of material) being substantially covered by the hardened plaster material. As will be described in more detail below, such a plaster board can be produced by drying wet plaster material while the continuous layer of material (or a precursor thereof) is disposed within the wet plaster material.

As noted above, in certain embodiments, each of the continuous layers of material is an acoustic layer, i.e., a layer that can provide the overall structure with reduced sound transmission (i.e., as compared to an otherwise identical plaster board lacking the acoustic layer). The acoustic layer can be, for example, a damping sheet. As used herein, a damping sheet can provide an increased damping loss to the overall structure (i.e., as compared to an otherwise identical plaster board lacking the damping sheet). While the detailed description of the present specification focuses primarily on damping sheets as an example, the person of ordinary skill in the art will appreciate that layers of other material can be present in the plaster board. For example, a different type of acoustic layer can be used (i.e., instead of or in addition to a damping sheet), e.g., a layer that decouples vibrations in one side of the body of plaster material from the other side of the body of plaster material, such as a foam or a fabric layer. And in still other embodiments, a different layer entirely can be used. For example, each of the continuous layers of material can be, for example, a polymer sheet, a fabric sheet, or a metal sheet. Such layers can provide a variety of properties to the plaster board, such as increased strength and increased nail pull-out values. And the person of ordinary skill in the art will appreciate that any combination of such layers can be used.

As described above, in certain embodiments, each of the continuous layers of material is a damping sheet. Such a damping sheet can have, for example, a damping loss factor greater than 1%, e.g., greater than 2%, or greater than 3%, or greater than 5%, or greater than 10%, for example, in the range of 1%-50%, or 2%-50%, or 3%-50%, or 5%-50%, or 10%-50%, or 1%-40%, or 2%-40%, or 3%-40%, or 5%-40%, or 10%-40%, or 1%-30%, or 2%-30%, or 3%-30%, or 5%-30%, or 10%-30%. This can be compared with the much lower value, lower than 1% for typical plaster materials such as gypsum. As referred to herein, and as would be appreciated by the person of ordinary skill in the art, a “damping loss factor” is a dimensionless metric of how efficient a material is at dissipating mechanical vibrations (e.g., sound waves) as heat. In a laminated gypsum board, as in other laminated structures, the working mechanism for noise and vibration control is known as constrained layer damping (CLD). Energy dissipation in laminated gypsum board is achieved by shearing the viscoelastic polymer between two layers of gypsum. The energy dissipation provided by the interlayer is quantified by the loss factor (ii), a dimensionless quantity that can be measured directly or predicted from the modal damping of a dynamic system based on the RKU algorithm. Several standards are available for measuring the damping of a laminated structure (e.g., SAE J1737 or ISP 16940-2009); however, as used herein, ASTM E75-05 is used to measure the damping loss factor. Damping loss factor is further described in Crane, R. and Gillespie, J., “A Robust Testing Method for Determination of the Damping Loss Factor of Composites,” Journal of Composites, Technology and Research, Vol. 14, No. 2, 1992, pp. 70-79; Kerwin et al., “Damping of Flexural Vibrations by means of Constrained Viscoelastic Laminate,” Journal of Acoustic Society of America, 1959, pp. 952-962; and Ross, D. et al., “Damping of Flexural Vibrations by Means of Viscoelastic laminate”, in Structural Damping, ASME, New York, 1959.

In certain embodiments as otherwise described herein, a continuous layer of material includes a carrier sheet with a polymer disposed thereon. As described in further detail below, such a continuous layer can be made by applying a precursor of the polymer on a carrier sheet, disposing the precursor-coated carrier sheet within a body of wet plaster material, and allowing the precursor to cure when within the body of plaster material (e.g., as the body of plaster material dries). Alternatively a pre-formed carrier sheet with the polymer disposed thereon can be disposed within a body of wet plaster material, which is then allowed to dry. In certain embodiments, for example, the continuous layer of material is a damping sheet that comprises a carrier sheet that has a damping polymer disposed thereon. In various embodiments, the damping polymer itself has a damping loss factor as described above for the overall sheet. In still further examples the carrier sheet with polymer or precursor is disposed between two dry layers of plaster material.

In alternative embodiments, a continuous layer of material is provided as a continuous sheet of material (i.e., without a carrier sheet), e.g., a sheet of polymer, a sheet of fabric, or a sheet of metal. The continuous layer can be, for example, a sheet of a damping polymer. As described in more detail below, such a continuous layer can be made in certain embodiments by disposing the continuous sheet or a precursor thereof in a body of wet plaster material and allowing the plaster to set, as described, e.g., in U.S. Patent Application Publication no. 2018/0171626.

As the person of ordinary skill in the art will appreciate, a variety of materials can be used as the damping polymer, for example, a so-called “viscoelastic polymer.” In various particular embodiments, the damping polymer is in the form of a glue, a resin, an epoxy, for example.

Desirably, the damping sheet and/or damping polymer exhibits large stress/strain delay or phase difference under loading. These materials can be characterized by Dynamic-Mechanical Analysis (DMA), a technique commonly used to measure the mechanical and damping properties of polymer materials. The shear modulus (also known as the modulus of rigidity) is defined as the ratio of shear stress to shear strain; in certain particular embodiments as otherwise described herein, the damping sheet and/or damping polymer has a shear modulus in the range of 10 kPa to 100 MPa, e.g., 10 kPa-50 MPa, or 10 kPa-10 MPa, or 10 kPa-1 MPa, or 50 kPa to 100 MPa, or 50 kPa-50 MPa, or 50 kPa-10 MPa, or 50 kPa-1 MPa, or 100 kPa to 100 MPa, or 100 kPa-50 MPa, or 100 kPa-10 MPa, or 100 kPa-1 MPa. This can be compared to the elastic modulus of plaster materials (e.g., GPa for gypsum).

In certain desirable embodiments of the plaster boards and methods as described herein, the damping sheet and/or damping polymer is substantially less rigid than the hardened plaster material. For example, in certain embodiments, the damping sheet is at least 20% less, or even at least about 40% less rigid or stiff than the body of hardened plaster material. There are a variety of tests of rigidity (e.g., SAE J1737 and ISP 16940-2009), but as used herein, rigidity is measured via ASTM E75-05. In other embodiments, the plaster board is substantially less rigid (e.g., at least 20% less rigid or at least 40% less rigid) than an otherwise identical plaster board lacking the one or more continuous layers of material (e.g., damping sheets).

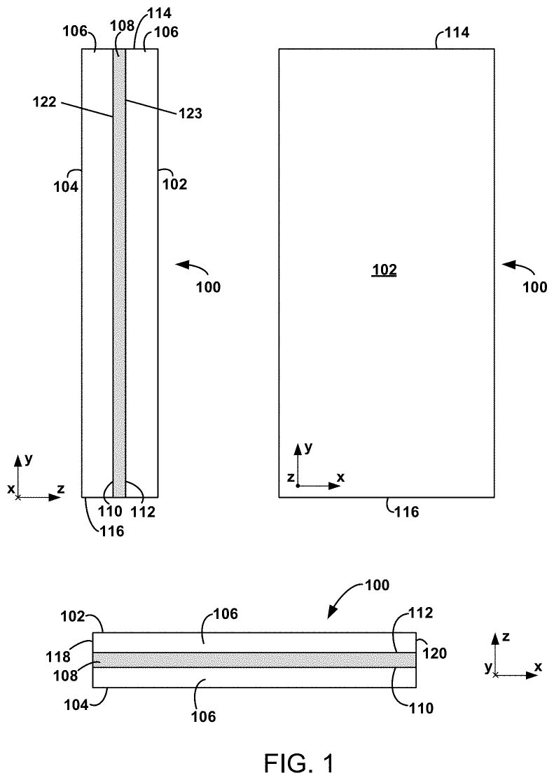

One embodiment of such a plaster board is described with respect to FIG. 1, which shows three views of a plaster board 100. The upper-left portion of FIG. 1 is a y-z plane view of the plaster board 100. The upper-right portion of FIG. 1 is an x-y plane view of the plaster board 100. The lower portion of FIG. 1 is an x-z plane view of the plaster board 100. The plaster board 100 includes opposing surfaces 102 and 104, a body of hardened plaster material 106 (including a first layer of hardened plaster material 107a and a second layer of hardened plaster material 107b), and an interlayer or damping sheet 108 having opposing sides 110 and 112, disposed within the body of hardened plaster material (i.e., between the first layer and the second layer).

In certain embodiments, a damping sheet completely separates the body of hardened plaster material into two sections. For example, in the example of FIG. 1, the body of hardened plaster material 106 may take the form of two sections (layers 107a and 107b) of hardened plaster material separated by the damping sheet 108. The body of hardened plaster material 106 may extend from the surface 102 to the surface 104 on opposite sides of the plaster board 100. While the hardened plaster material may be separated into two non-touching sections, for the purposes of the description herein the hardened plaster material is nonetheless considered to be a single “body.” In other embodiments, the one or more damping sheets do not extend throughout the entire plane of the board, and thus allow the entire body of hardened plaster material to be continuous.

As the person of ordinary skill in the art will appreciate, the plaster boards described herein may be made using a variety of different inorganic base materials. For example, in certain embodiments of the plaster boards and methods as otherwise described herein, the plaster material comprises a base material that is a gypsum material. In other embodiments of the plaster boards and methods as otherwise described herein, the plaster material comprises a base material that is, for example, lime or cement. In certain embodiments, the body of hardened plaster material includes two base materials, for example, one generally on one side of the one or more sheets of damping material, and the other on the other side of the one or more sheets of damping material. The hardened plaster material may include one or more fillers or additives in the base plaster material(s), e.g., fiberglass, a plasticizer material, a foaming agent, and/or ethylenediaminetetraacetic acid (EDTA).

In plaster board 100 of FIG. 1, the damping sheet 108 is disposed within the body of hardened plaster material 106, i.e., between layers 107a and 107b. In the embodiment of FIG. 1, the opposing sides 110 and 112 of the damping sheet 108 are substantially covered by the body of hardened plaster material 106, such that substantially none of the damping material is visible at either of the first surface or the second surface of the plaster board.

As described above, in various embodiments of the plaster boards and methods as described herein, the damping sheet 108 is made up of a carrier sheet having a damping polymer disposed thereon. The carrier sheet (whether used in a damping layer or in a different continuous layer) can be formed from a variety of materials, e.g., sheet materials that are capable of carrying a damping polymer. For example, in certain embodiments of the plaster boards and methods as described herein, the carrier sheet comprises (or is) a paper sheet. In other embodiments of the plaster boards and methods as described herein, the carrier sheet comprises (or is) a fiberglass mat or a fiberglass fabric. In other embodiments of the plaster boards and methods as described herein, the carrier sheet comprises (or is) a woven or non-woven fabric, such as a felt. In other embodiments of the plaster boards and methods as described herein, the carrier sheet comprises (or is) a sheet of foamed polymer, e.g., the foamed polymer sheet sold by BASF under the trade name BASOTECT. In other embodiments of the plaster boards and methods as described herein, the carrier sheet comprises (or is) a polymer sheet, e.g., a thin polymer sheet of the type typically used as a plastic release liner for an adhesive, which can be, for example in the range of 0.001-0.002″ thick. In other embodiments, the carrier sheet can be an adhesive sheet, e.g., with adhesive such as a pressure-sensitive adhesive presented at one or both surfaces thereof. Such pressure-sensitive adhesive sheets can be formed from a core sheet (made, e.g., from PVC or PET) with adhesive (e.g., a silicone pressure-sensitive adhesive or a polyacrylate adhesive) disposed on both sides thereof. Any release liners can be removed before use

The damping polymer may include or be filled with a fire resistant material (e.g., zinc borate) and/or a mold resistant material.

The damping polymer can be disposed on the carrier sheet in variety of manners. For example, in certain embodiments of the plaster boards and methods as described herein, the damping polymer is impregnated on the carrier sheet (e.g., when the carrier sheet has some level of porosity). In certain embodiments, the damping polymer is formed as a layer on one or both sides of the carrier sheet. The damping polymer can, for example, be impregnated into the pores of the carrier sheet and form layers on either side of the carrier sheet.

As noted above, a variety of damping polymers can be used in the plaster boards and methods of the disclosure. In various embodiments of the plaster boards and methods as described herein, the viscoelastic polymer is polyvinyl butryal, a silicone, or an acrylic. The viscoelastic polymer can be a thermally-cured material, e.g., a cured adhesive such as those available under the tradenames GreenGlue. Various viscoelastic glues made by Weber may also be suitable for use. Damping polymer compositions are also described in U.S. Pat. Nos. 8,028,800 and 9,157,241, each of which is hereby incorporated herein by reference in its entirety.

Each of the continuous layers (e.g., each damping sheet) can, but need not extend to all edges of the plaster board. For example, in the embodiment of FIG. 1, the damping sheet extends substantially throughout the body of hardened plaster material 106 within the x-y plane and/or substantially parallel to the surfaces 102 and 104, to all four edges of the rectangular board. In certain embodiments, the damping sheet extends to at least two opposed lateral edges of the plaster board. For example, the damping sheet 108 of the embodiment of FIG. 1 extends from the edge 114 to the edge 116 and from the edge 118 to the edge 120.

As the person of ordinary skill in the art will appreciate, each of the continuous layers (e.g., each damping sheet) is desirably embedded substantially within the plaster board. For example, in certain embodiments of the plaster boards and methods as otherwise described herein, the thickness of the plaster body on one side of the continuous layer (e.g., damping sheet) is within the range of 33%-300% (e.g., 50%-200%, or 75%-150%) of the thickness of the plaster body on the other side of the continuous layer (e.g., damping sheet). In certain such embodiments, the thickness of the plaster body on one side of the continuous layer (e.g., damping sheet) is within 10% of the thickness of the plaster body on the other side of the continuous layer (e.g., damping sheet). For example, in the embodiment of FIG. 1 (as shown in the lower portion thereof), the section of the body of hardened plaster material 106 that is above the damping sheet 108 is substantially equal in thickness along the z-axis when compared to the section of the body of hardened plaster material 106 that is below the damping sheet 108. Of course, in other examples, the respective sections of the body of hardened plaster material above and below the continuous layer (e.g., damping sheet) may have unequal thicknesses along the z-axis. This variability in the placement of the damping sheet may affect the sound damping characteristics of the plaster board as described below. And in other embodiments, the variability in placement of a continuous layer may affect other characteristics of the plaster board, such as mechanical strength, nail pull strength and score-snap performance; the person of ordinary skill in the art will select a desired placement to provide the desired properties to the board. Moreover, the different layers of the hardened plaster material can have different densities and/or microstructures (or other properties), e.g., through the differential use of fillers or foaming agents; this, too, can be used to tailor board properties, particularly acoustic properties.

In certain embodiments of the plaster boards and methods as otherwise described herein, there is at least 0.15, or even at least 0.2 inches of thickness of the plaster board material between the continuous layer (e.g., damping sheet) and the first surface of the plaster board, and between the continuous layer (e.g., damping sheet) and the second surface of the plaster board.

The plaster boards of the present disclosure may be made in a variety of thicknesses. The person of ordinary skill in the art will select a desirable thickness for a particular end use. In certain embodiments of the plaster boards and methods as otherwise described herein, the total thickness of the plaster board (i.e., along the z-axis between the surfaces 102 and 104 of FIG. 1) is at least 0.25 inches and no more than 2 inches, e.g., in the range of 0.30 inches to 1.25 inch. or in the range of 0.5 inch to 1 inch. In certain particular embodiments, the total thickness of the plaster board is substantially equal to 0.375 inches. In other particular embodiments, the total thickness of the plaster board is substantially equal to 0.5 inches. In still other particular embodiments, the total thickness of the plaster board is substantially equal to 0.625 inches. And in still other particular embodiments, the total thickness of the plaster board is substantially equal to one inch (e.g., especially when lower density plaster materials are used).

As noted above, the use of a layer of material within the body of a plaster board can help to improve a number of properties of the plaster board. This can be especially desirable when the plaster material has a relatively low density, as such low density materials, while light and therefore desirable for an installer, can have relatively worse properties as compared to higher density materials. But use of a layer can described herein can help improve the properties of such materials, e.g., nail pull values. In certain embodiments, the hardened plaster material has a density in the range of 0.40-0.65 g/cm3.

The person of ordinary skill in the art will appreciate, however, that the presently disclosed methods and boards can be of a variety of thicknesses and weights. For example, the board can be a lightweight board ⅝″ in thickness with a weight on the order of 1400 lb/MSF (MSF=1,000 square feet), or can be a lightweight board 1″ in thickness with a weight on the order of 2240 lb/MSF. Generally, boards can be made in any desirable weight, for example, from lightweight (1200 lb/MSF) to normal weight (2000 lb/MSF) to heavy weight (3000 lb/MSF), in any desirable thickness (e.g., ½″, ⅝″ or 1″ thick). And as the person of ordinary skill in the art will appreciate, additional thin layers of plaster material (e.g., gypsum, usually of higher density than the bulk material) can be applied to the outsides of the paper or fiberglass layers cladding the plaster material core, in order to help improve mechanical strength.

In some embodiments, the plaster board 100 includes a score-and-snap element 122, 123. The score-and-snap element 122, 123 improves the score-and-snap performance of the plaster board 100, for example by reducing the risk of delamination of the hardened plaster material 106 and the damping sheet 108. In some forms, the score-and-snap element 122, 123 improves score-and-snap performance by improving adhesion between the damping sheet 108 and the hardened plaster material 106. Alternatively or additionally, the score-and-snap element 122, 123 improves score-and-snap performance by directing crack propagation within the damping sheet 108 and/or the hardened plaster material 106.

In some example embodiments, the score-and-snap element 122, 123 includes at least one of a textured or embossed surface 110, 112 of the damping sheet 108, a textured or embossed surface 120, 121 of the hardened plater material 106, a material miscible with the damping sheet 108 and the plaster material 106, one or more brittle layers within the damping sheet 108, one or more extra dense or brittle layers within the plaster material 106, a plurality of pores within the damping material 108. Each of these examples of a score-and-snap element 122, 123 are discussed in greater detail below.

In one example, the score-and-snap element 122, 123 includes a plurality of pores within the damping material 108. In operation, the plaster board 100 is shaped by the installer through scoring and snapping. One surface 102 of the plaster board 100 is scored, cutting the outer paper or fiber layer and cutting into the hardened plaster material 106. The plaster board 100 is then bent, causing the score to propagate through the thickness of the plaster board 100.

The bending of the scored plaster board 100 creates crack tip stress and bending stress within the plaster board 100. The crack tip stress acts to extend the scoring, resulting in a desirably clean snap. The bending stress extends along defects within the plaster board 100, potentially extending away from the desired snap line. To ensure a desirable snap, the crack tip stress must dominate over the bending stress.

To improve the likelihood of crack tip stress dominating, pores are included within the damping sheet 108 in order to tune the elastic moduli thereof. Specifically, the addition of pores within the damping sheet 108 can reduce the elastic modulus thereof. Different positioned, sized, and/or shaped pores can be used to tune the elastic modulus of the damping sheet 108 to a desired level.

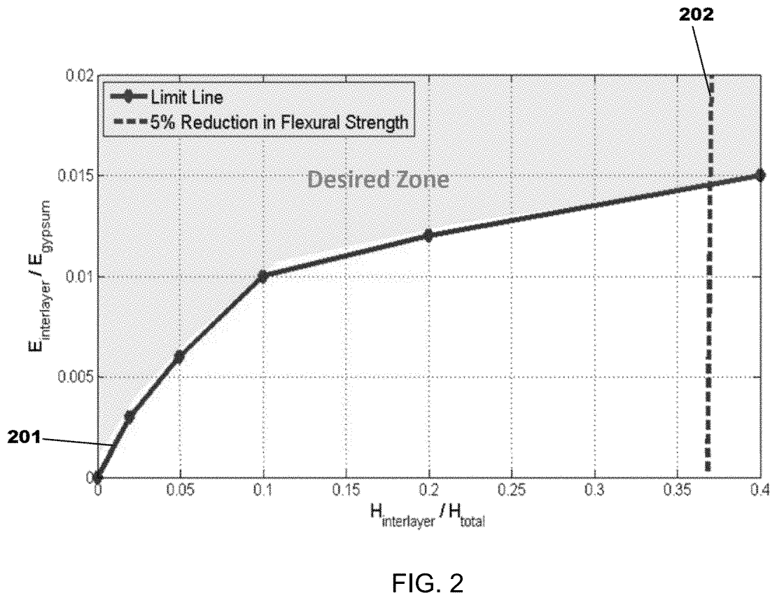

FIG. 2 charts the elastic modulus of a damping sheet 108 versus the thickness of the damping sheet 108. The elastic modulus of the damping sheet 108 is given as a fraction of the elastic modulus of the hardened plaster material 106. The limit line 201 represents the minimum desired elastic modulus of the damping sheet 108. The chart of FIG. 2 is based on a ⅝″ think plaster board 100 in which the hardened plaster material 106 is a foamed gypsum material. However, it is understood that the same principal can be used to improve the score-and-snap performance of plaster boards 100 having different thicknesses and/or different hardened plaster materials 106.

In some example embodiments, the damping sheet 108 is a porous material having an elastic modulus of at least about 0.5% of the elastic modulus of the hardened plaster material 106 and a thickness of at least about 8% the overall thickness of the plaster board 100 or about 0.05 inches. In a further example, the damping sheet 108 is a porous material having an elastic modulus of at least about 1% of the elastic modulus of the hardened plaster material 106 and a thickness of at least about 16% the overall thickness of the plaster board 100 or about 0.1 inches.

The thickness limit line 202 represents a maximum desired thickness of the damping sheet 108. Using a damping sheet 108 having a thickness greater than the limit line 202 can result in a plaster board 100 having a lower flexural strength. As shown, the use of damping sheet 108 having a higher elastic modulus allows for a thicker damping sheet 108 layer. In some examples, the damping sheet 108 has a thickness of less than about 0.4 inches or about 64% of the overall thickness of the plaster board 100.

In some examples, the porous damping sheet 108 is an extruded polymer foam material. The polymer foam is extruded inline during the manufacturing of the plaster board 100 and coated on both sided with wet slurry. The wet slurry dries to form the hardened plaster material 106. Alternatively, the extruded polymer foam material is adhered between two layers of already hardened plaster material 106. Alternatively or additionally, a material is added to the slurry 306A, 306B to improve adhesion thereto. In some examples, the slurry includes bond starch.

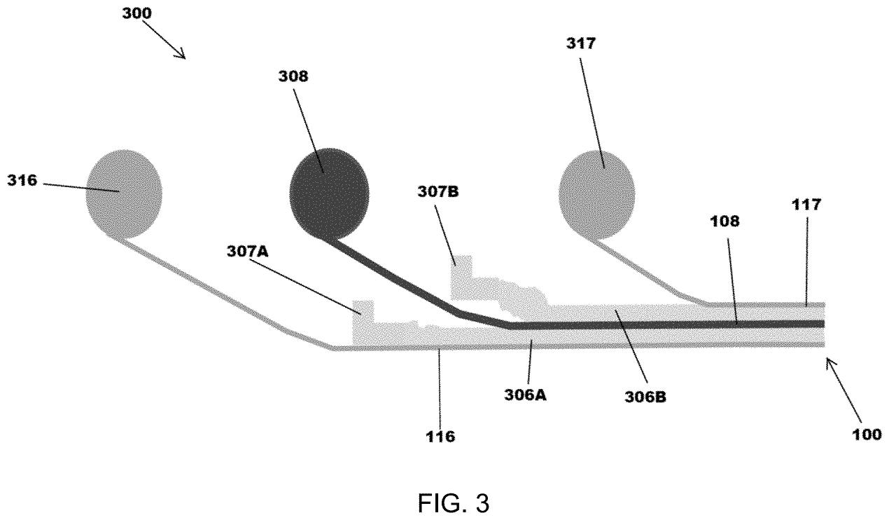

FIG. 3 illustrates a simplified manufacturing system 300 for producing a plaster board 100 that is laminated inline. The manufacturing system 300 includes a roll 316 of front panel material 116, a roll 308 of damping sheet 108, a roll 317 of back panel material 117, and slurry applicators 307A, 307B. In some applications, the manufacturing system 300 further includes one or more adhesive applicators to apply adhesive between layers of the laminate to bind the plaster material 106 to the damping material 108 and/or the front and back panels 116, 117. In one example, layers of adhesive or epoxy are applied to both sides of the damping layer 108 to couple the damping layer 108 to the layers of plaster material slurry 306A, 306B. Alternatively or additionally, the damping material 108 acts as an adhesive, adhering the layers of plaster material together. In one example, the damping layer 108 is applied in a melted state to act as a hot melt adhesive. In another example, the damping layer 108 includes a tackifier to increase the adhesiveness thereof.

During production, the front panel 116 is unrolled from the roll 316 with the outer surface 104 facing down, so as to form a bottom layer of the laminate. The one or more applicators 307A apply a first layer of plaster material slurry 306A, such as gypsum slurry, to the inner surface of the front panel 116. In some examples, additional equipment is positioned in line after the applicator 307A to smooth the slurry 306A into a layer having a uniform thickness.

The roll 308 of damping sheet 108 is positioned inline after the first applicator 307A. The damping sheet 108 is applied to the top surface of the first layer of slurry 306A. In some examples, the damping sheet 108 is an extruded polymer foam material as discussed above. In some forms, the damping sheet 108 comprises thermoplastic polyurethane elastomer, polyether thermoplastic polyurethane elastomer, polyester thermoplastic polyurethane elastomer, polyvinylidene difluoride, a polyvinylidene difluoride and hexafluoropropylene composite, acrylic, acrylic glass composite, acrylic polyurethane composite, acrylic tape with hollow glass beads, polyvinyl butryal, rubber, rubber and carbon black composite, ethylene methyl acrylate copolymer, or combinations thereof.

As shown, the damping sheet 108 is preformed and rolled. In alternative embodiments, the damping sheet 108 is extruded inline in the system 300. In still further alternatives, the damping sheet 108 is applied in a wet state by an applicator or sprayer to the first layer of slurry 306A.

One or more applicators 307B apply the second layer of slurry 307B to the top surface of the damping sheet 108. As with the first layer of slurry 307A, the system 300 may include a smoothing device inline after the second applicators 307B for smoothing the slurry 307B into a uniform layer. The back panel 107 is unrolled from the roll 307 and applied to the outer surface of the slurry 307B to form the plaster board 100. While the embodiment shown in FIG. 3 has the front panel 106 forming the bottom of the laminate, it is understood that the rolls 306 and 307 could be switched such that the bottom layer is form by the back panel 107.

As discussed above, in some examples the damping sheet 108 is coupled to the hardened plaster material 106 by an adhesive or epoxy. Alternatively or additionally, the plaster board 100 includes a score-and-snap element comprising one or more materials that are miscible with both the plaster material 106 and the damping sheet 108.

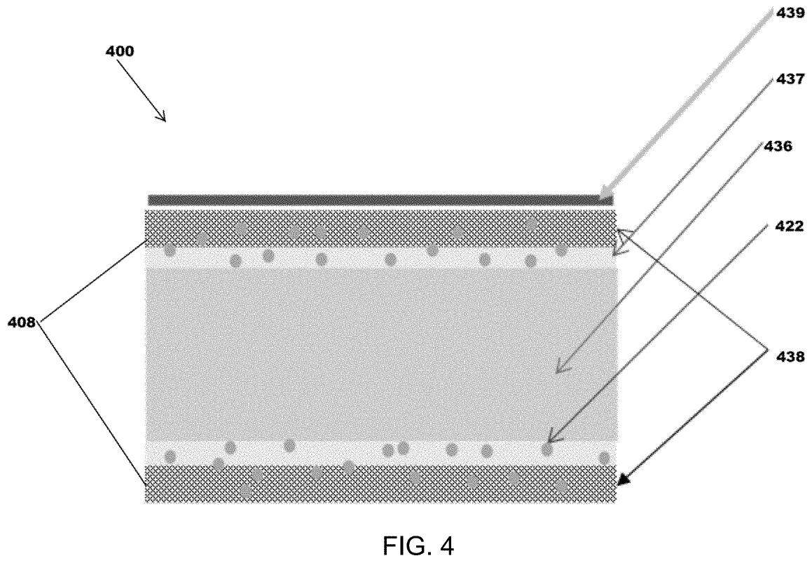

Turning to FIG. 4, a plaster board 400 is shown having a layer of hardened plaster material 406 between two damping sheets 408. The damping sheets 408 are formed of a glass mat 438 coated with a polymer coating 439. However, it is understood that other damping sheet materials can be used, such as those listed above. The hardened plaster material 406 is formed of a core layer 436 and two coat layers 437. In alternative embodiments, the hardened plaster material 406 is one uniform layer.

The plaster board 400 includes a reactive binder 422 which couples the hardened plaster material 406 to the damping sheet 408. The reactive binder 422 is miscible with both the damping sheet 408 and the hardened plaster material 406 and thus acts as a score-and-snap element by reducing delamination between the hardened plaster material 406 and the damping sheet 408. Accordingly, the reactive binder 422 increases the amount of force required to delaminate the hardened plaster material 406 and the damping sheet 408.

In some examples, the polymer coating 439 includes poly(ethylene-co-methacrylic acid). The binder 422 is a mixture of urea formaldehyde and a reactive all acrylic polymer. In some forms, the reactive all acrylic polymer is a n-methylolacrylamide (MOA)/acrylamide copolymer (e.g., about 70%/about 30%).

The hardened plaster material 406 includes a reactive material for reacting with the binder 422. In some examples, the reactive material comprises a hydrophobic styrene-acrylic reactive copolymer. In some forms, the hydrophobic styrene-acrylic reactive copolymer comprises a reactive monomer mixture of n-methylolacrylamide (MOA) and acrylamide (e.g., about 70%/about 30%). The reactive material is included in the coat layers 437 of the hardened plaster material 406. In alternative embodiments, the reactive material is mixed in throughout the hardened plaster material 406.

Similarly, the polymer coating 439 includes a reactive material. In some examples, the polymer coating includes an ethylene-methacrylic acid copolymer.

In operation, the binder 422 reacts with the reactive materials in the hardened plaster material 406 and the damping sheet 408. The reaction forms a mixture along the interface between the hardened plaster material 406 and the damping sheet 408 such that the binder 422 extends into both the hardened plaster material 406 and the damping sheet 408.

In alternative embodiments, other reactive binder 422 and reactive materials are used. Other example reactive binders 422 include an anhydride (such as maleic anhydride), carboxylic acid, (meth)acrylic acid, itaconic acid, hydroxyethyl methacrylate, hydroxypropyl methacrylate, and other hydroxyls, and/or an epoxide (such as glycidyl methacrylate). Other examples of reactive additives for the hardened plaster material 406 and/or damping sheet 408 include urea-formadehyde, carboxylic acid, hydroxyl, epoxide, and/or an anyhydride (such as a styrene-maleic anhydride copolymer).

Although the plaster board 400 comprises an inner layer of hardened plaster material 406 and two outer layers of damping sheets 408, it is understood that the same reactive binder 422 could be used in a plaster board having an inner damping sheet and outer hardened plaster material, such as the plaster board 100 discussed above.

As shown above, the hardened plaster material includes a core layer 436 and coat layers 437. The use of multiple different layers of plaster material can further improve score-and-snap performance by varying the density of the layers such that the plaster material closer to the damping sheet 408 has a higher density than the plaster material further from the damping sheet 408. In one example, the core layer 436 is foamed to decrease the density thereof and the coat layers 437 are not foamed. In alternative embodiments, the coat layers 437 are foamed to a lesser degree than the core layer 436. In still further alternatives, the coat layers 437 include an additive to increase the density thereof. In other alternative examples, the plaster material is not divided into discrete layers having different densities. The plaster material has a gradually varying density wherein the density proximate the damping sheet is higher than the density distal from the damping sheet.

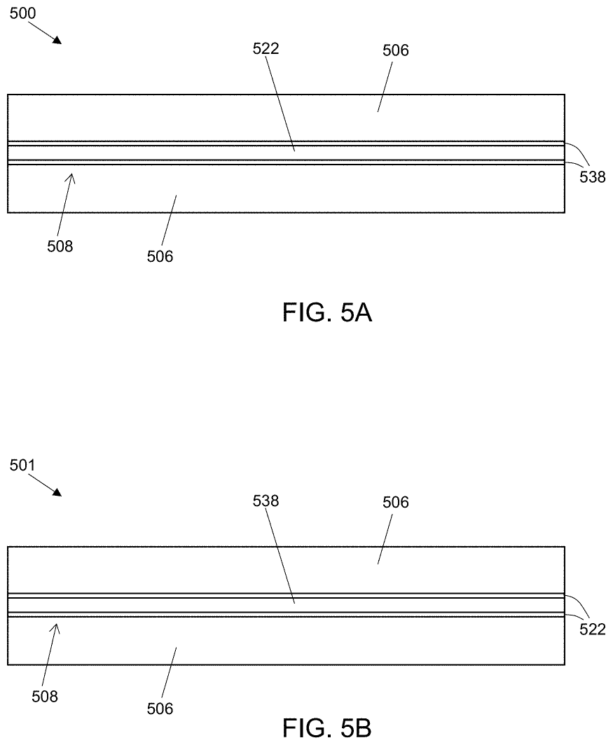

FIG. 5A illustrates a plaster board 500, and FIG. 5B illustrates a plaster board 501. Each plaster board has composite damping sheet 508 comprising a brittle material 522 and a viscoelastic material 558. The brittle layers within the damping sheets 508 serve as score-and-snap elements, improving the score-and-snap performance of the plaster boards 500, 501.

Turning first to the plaster board 500, the damping sheet 508 has a central brittle layer 522 coated on both sides with a viscoelastic glue 558. In operation, the viscoelastic glue 558 dampens sound. The viscoelastic glue 558 additionally adheres the damping sheet 508 to the hardened plaster material 506. In some examples, the viscoelastic glue 558 comprises an acrylic polymer, such as those listed above. Alternatively or additionally, the viscoelastic glue 558 is foamed. In one example, the viscoelastic glue comprises a vinyl-bond rich styrene ethylene ethylene propylene styrene copolymer.

The brittle layer 522 is a sheet of material having a higher elastic modulus than the viscoelastic glue. In some examples, the brittle layer 522 is a glass mat. In alternative examples, the brittle layer 522 is formed of a plaster material, such as gypsum.

The second plaster board 500 has a damping sheet 508 formed of a central viscoelastic layer 558 between two layers 522 of brittle material. In some examples, the viscoelastic material 558 is formed of one of the materials listed above. The brittle material layers 522 are formed of a material having a higher elastic modulus than the viscoelastic material 558. In some examples, the brittle material layers 522 are formed of one of a glass mat or a plaster material.

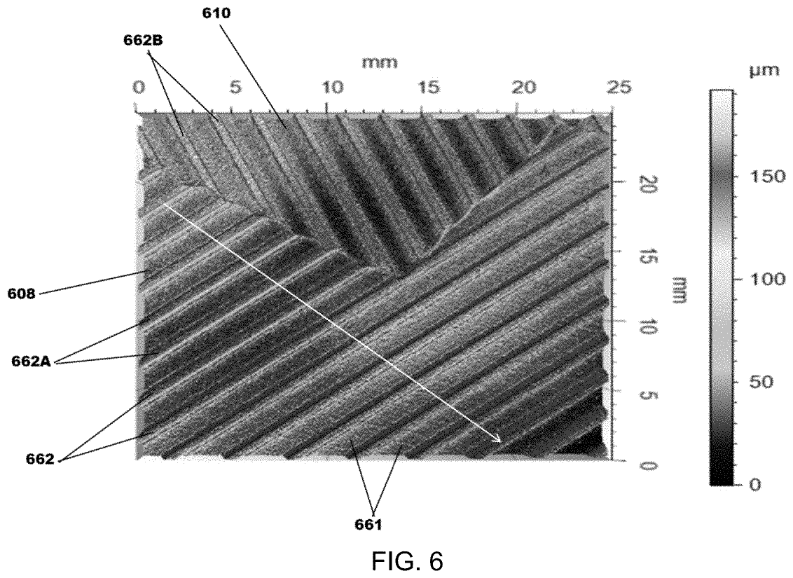

FIG. 6 illustrates a surface 610 of a damping sheet 608 for use in a plaster board, such as the plaster boards 100, 500 discussed above. As shown, the surface 610 has a textured profile (e.g., by being embossed) so as to have a series of peaks 661 and valleys 662. The valleys 662 includes a first set 662A and a second set 662B which are substantially perpendicular to each other, so as to form a camo pattern. However, it is understood that other textured profiles can be used, and no set pattern need be used. In one example, the valleys 662 are about 1 mm wide and about 100 micrometers deep.

Providing a textured profile of the surface 610 of the damping sheet 608 increases the surface area thereof. The increased surface area improves adhesion between the damping sheet 608 and the hardened plaster material (not shown). Thus, the embossed surface 610 acts as a score-and-snap element by reducing instances of delamination between the hardened plaster material and the damping sheet 608.

During manufacturing, the damping sheet 608 can be embossed prior to lamination with the hardened plaster material. In some examples, the damping sheet 608 is embossed by a press. In alternative examples, the damping sheet 608 is embossed by a roller or scraper. In still further examples, the damping sheet 608 is formed with an embossed surface 610. For example, a foamed damping sheet 608 is sprayed onto a hardened plaster material in a pattern such that the surface 610 is embossed.

While only one surface 610 of the damping sheet 608 is shown, it is understood that the opposing side can be similarly embossed to aid in adhesion to the other layer of hardened plaster material. Alternatively or additionally, the inner surface of the hardened plaster material are similarly embossed.

One example pattern is described above. It is understood that the features can be provided in a variety of other arrangements or patterns, both regular and irregular. In various examples, the one or more raised features have one or more of a cross-hatched pattern or a honeycomb pattern. In some examples, the one or more raised features include a plurality of raised ridges that are parallel to each other. But the person of ordinary skill in the art will appreciate that these are only examples, and that myriad other arrangements are possible.

The embossing occupies a substantial surface area of the damping sheet 608. For example, in certain embodiments the embossing occupies a fraction of the surface area of the surface 610 of the damping sheet 608 in a range of about 10% to about 90% of the surface area. In some embodiments, the embossing occupies about 20% to about 80% of the surface 610. In still further embodiments, the embossing occupies about 30% to about 70% of the surface 610.

As shown above, the peaks 661 are spaced apart by valleys 662. In some embodiments, the average spacing between peaks 661 is between about 0.1 mm and 5 mm. In various such embodiments, the peaks 661 have an average spacing between features in the range of 0.1 mm to 3 mm, or 0.1 mm to 2 mm, or 0.1 mm to 1 mm, or 0.5 mm to 5 mm, or 0.5 mm to 3 mm, or 0.5 mm to 2 mm, or 1 mm to 5 mm, or 1 mm to 3 mm. A person of ordinary skill in the art can, based on the disclosure herein, provide a spacing in conjunction with the pattern type and depth to provide a desired degree of adhesion between the damping sheet 608 and a hardened plaster material.

In addition to varying the spacing between peaks 661, the depth of the valleys 662 can be varied to affect adhesion. In certain embodiments as otherwise described herein, the one or more valleys 662 have a depth in the range of 20-150 μm. For example, in various embodiments, the one or more valleys 662 have a depth within a range of 75 μm to 95 μm, within a range of 50 μm to 115 μm, or within a range of 35 μm to 130 μm. In certain embodiments, the one or more valleys 662 define a first plurality of valleys 662A that are substantially parallel to each other and a second plurality of valleys 662B substantially parallel to each other. In this context, the valleys 662A of the first plurality might not be parallel with the valleys 662B of the second plurality. More specifically, the one or more raised features may, for example, include a first section that includes the first plurality of valleys 662A and a second section that includes the second plurality valleys 662B. In this context, the first section may in certain embodiments be adjacent to the second section, as shown.

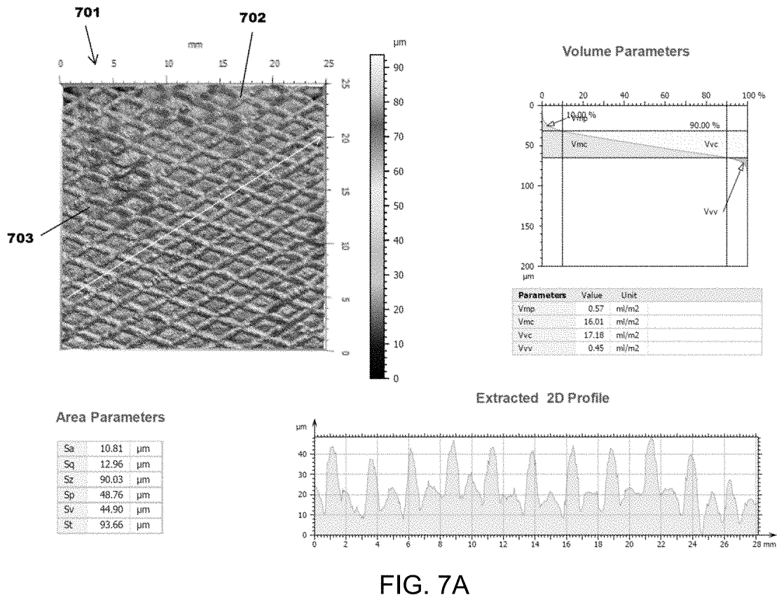

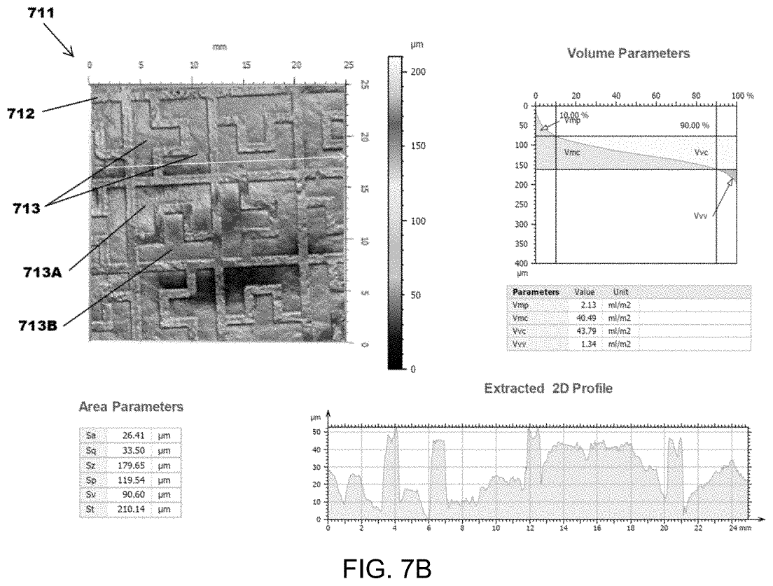

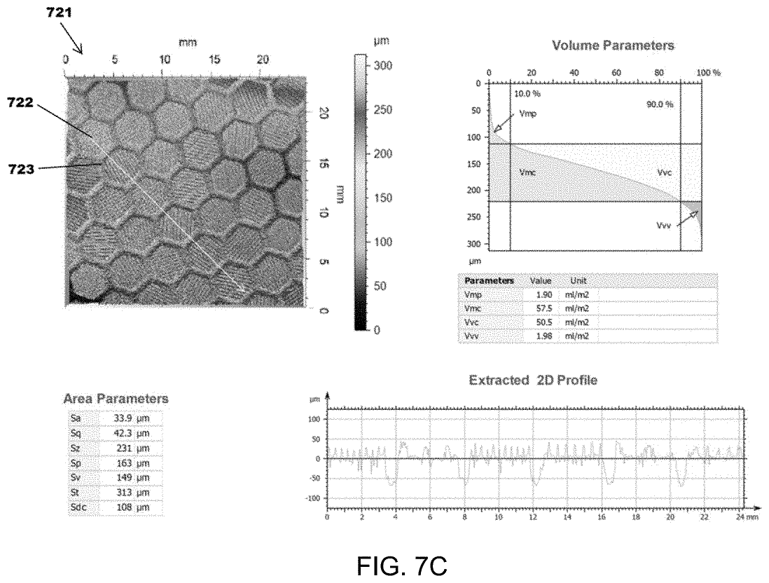

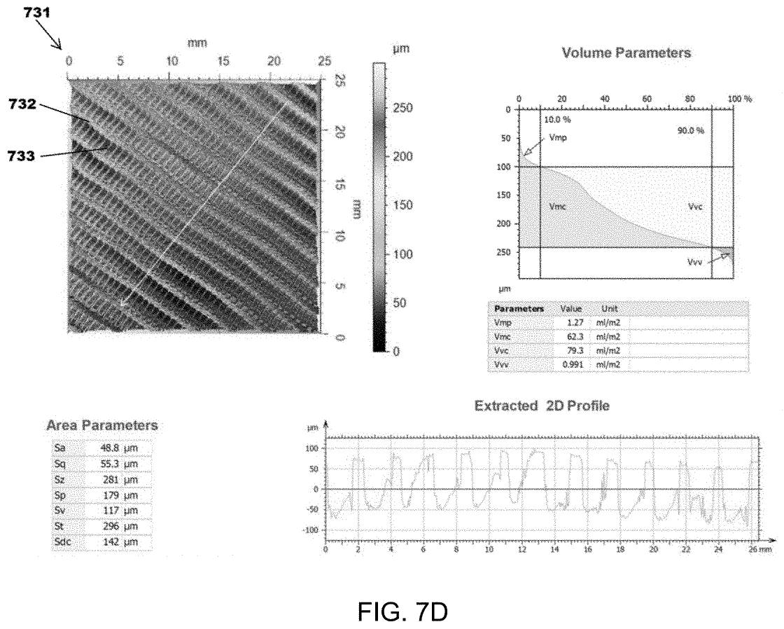

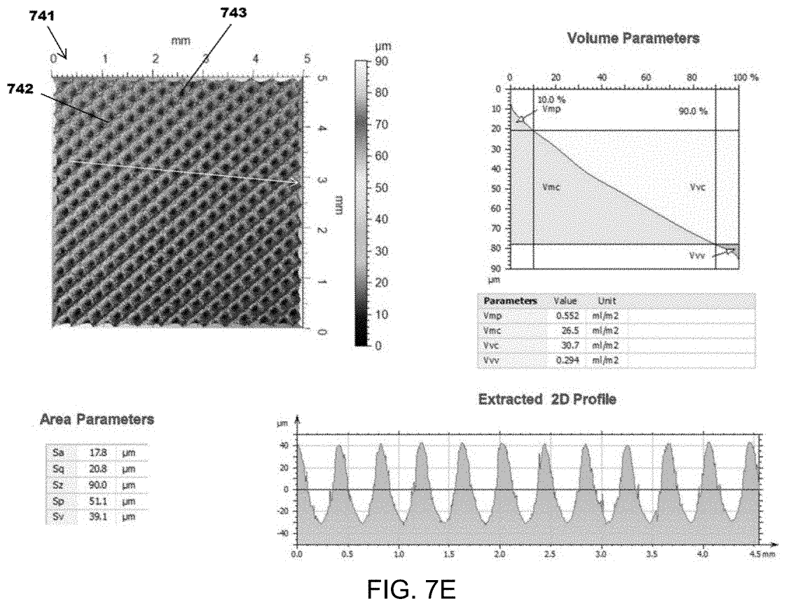

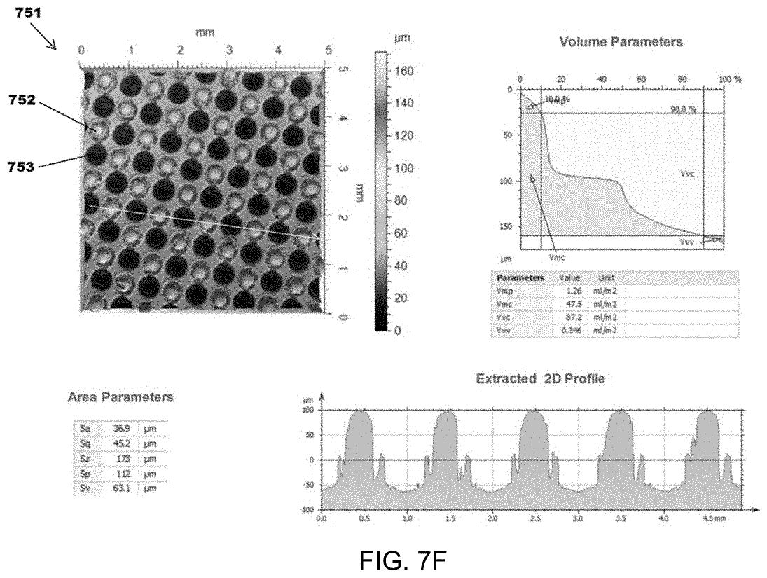

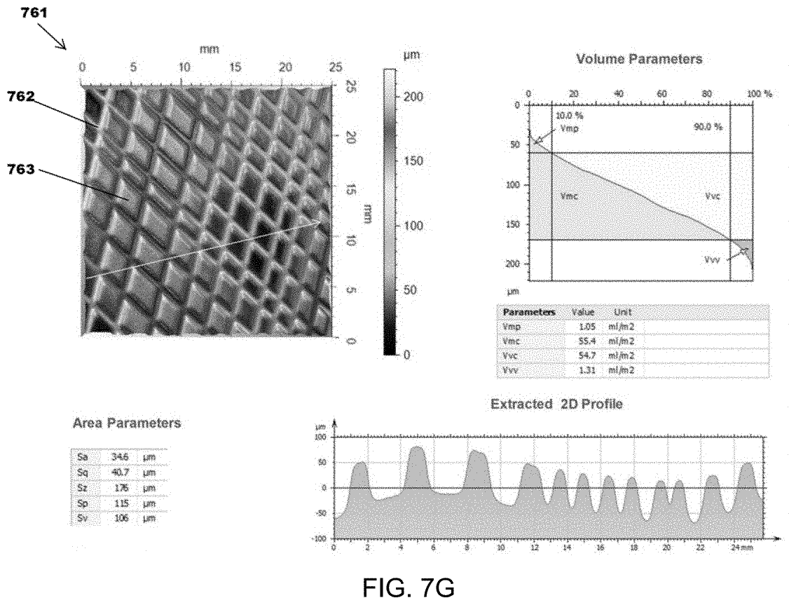

A variety of example embossing patterns are illustrated in FIGS. 7A-7G. FIG. 7A illustrates a diamond pattern 701. The diamond pattern 701 comprises a plurality of diamond shaped valleys 773 defined by a grid of peaks 702. The peaks 702 have an average width of about 1 mm. The peaks 702 are about 20 micrometers to about 40 micrometers higher than the valleys 703.

FIG. 7B illustrates a CT pattern 711. The CT pattern 711 includes a plurality of valleys 713 defined by peaks 712. The valleys 713 are arranged as interlocking pairs of C shaped valleys 713A and T shaped valleys 713B. The peaks 712 are about 10 micrometers to about 50 micrometers higher than the valleys 713. The peaks 712 have an average width of about 1 mm to about 2 mm. Each CT pair of valleys 713 occupies a substantially square area having a width of about 6 mm to about 10 mm. In one example, the CT pair has a width of about 7.5 mm.

FIG. 7C illustrates a honeycomb pattern 721. The pattern 721 is formed of a plurality of substantially hexagonal peaks 722 defined by valleys 723. The sides of the hexagonal peaks 722 have a length of about 2 mm to about 3 mm. The valleys 723 have a width of about 1 mm. the tops of the peaks 722 are about 40 micrometers to about 150 micrometers higher than the bottoms of the valleys 723.

FIG. 7D illustrates a lined pattern 731. The pattern 731 is formed of a plurality of substantially parallel valleys 733 defined by peaks 732. The valleys 723 have a width of about 1 mm. The peaks have a width of about 2 mm. The tops of the peaks 722 are about 75 micrometers higher than the bottoms of the valleys 723.

FIG. 7E illustrates an izmir pattern 741. The pattern 741 includes a plurality of bowl shaped valleys 743 arranged in diagonal rows. The rows of valleys 743 are separated by peaks 742. The peaks 742 have an average width of about 0.1 mm. The valleys 743 have an average diameter of about 0.2 mm to about 0.3 mm. The tops of the peaks 742 are about 70 micrometers to about 80 micrometers higher than the bottoms of the valleys 743.

FIG. 7F illustrates a Spiga pattern 751. The pattern 751 includes a plurality of hemispherical peaks 752 and hemispherical valleys 753. The peaks 752 and valleys 753 each have a diameter of about 0.3 mm to about 0.5 mm. The tops of the peaks 752 are about 150 micrometers higher than the bottoms of the valleys 753.

FIG. 7G illustrates a spiro pattern 761. The pattern 761 includes a plurality of rectangular valleys 763 defined by a grid of peaks 762. The valleys 763 are arranged into diagonal rows. The rows of valleys 763 have varying widths, varying from less than 1 mm to about 3 mm. The peaks 762 have a width of about 1 mm. The tops of the peaks 762 are about 50 micrometers to about 100 micrometers higher than the bottoms of the adjacent valleys 763.

As discussed above, each of the patterns shown in FIGS. 7A-7G are illustrative examples, It is understood that other patterns of embossing can be used to increase the adhesion between a damping sheet and adjacent hardened plaster material.

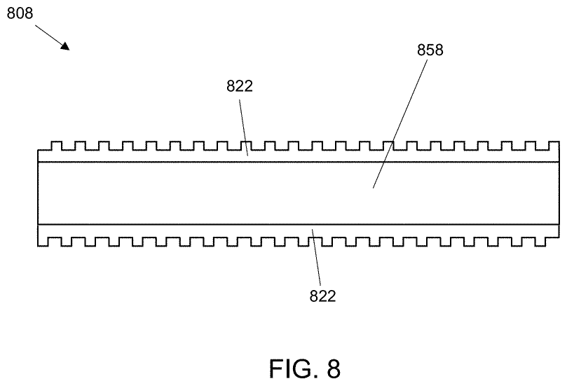

The examples discussed above are used to describe individual score-and-snap elements usable in a plaster board. It is understood that these score-and-snap elements can be combined within a single plaster board product. In some examples, a plaster board product comprises first and second layers of hardened plaster material with a damping sheet therebetween. The damping sheet 808 comprises two brittle layers 822 with a viscoelastic layer 858 therebetween as shown in FIG. 8. At least one of the brittle layers 822 has an embossed surface. The embossed surfaces of the brittle layers 822 improve adhesion to the hardened plaster material (not shown) to thereby improve score-and-snap performance of the plaster board.

In one example, the plaster board additionally includes a reactive binder including at least one component miscible in the hardened plaster material and the damping sheet.

Various additional embodiments and aspects of the disclosure are provided by the enumerated embodiments below, which may be combined in any number and in any combination that is not logically or technically inconsistent.

Embodiment 1. A plaster board comprising:
a first layer of hardened plaster material comprising a first surface and an opposed second surface;
a second layer of hardened plaster material comprising a first surface and an opposed second surface, wherein the first surface of the second layer faces the first surface of the first layer;
a viscoelastic interlayer disposed between the first surface of the first layer and the first surface of the second layer, wherein the interlayer includes a score-and-snap element.
   Embodiment 2. The plaster board of embodiment 1 wherein the score-and-snap element comprises at least one of surface having a textured profile, a layer of brittle material, a plurality of pores, or a binder miscible in the hardened plaster material.
   Embodiment 3. The plaster board of embodiment 1, wherein the score-and-snap element comprises a surface having a textured profile.
   Embodiment 4. The plaster board of embodiment 3, wherein the surface having the textured profile is an embossed surface.
   Embodiment 5. The plaster board of any of embodiments 1˜4 wherein the score-and-snap element comprises a layer of brittle material.
   Embodiment 6. The plaster board of embodiment 5 wherein the layer of brittle material is a glass mat.
   Embodiment 7. The plaster board of embodiment 5 wherein the score-and-snap element comprises a plurality of layers of brittle material.
   Embodiment 8. The plaster board of any of embodiments 1-7 wherein the score-and-snap element comprises a plurality of pores.
   Embodiment 9. The plaster board of any of embodiments 1-8 wherein the score-and-snap element comprises a binder miscible in the hardened plaster material.
   Embodiment 10. The plaster board of any of embodiments 1-9 wherein the viscoelastic interlayer comprises at least one layer of brittle material and at least one layer of viscoelastic material.
   Embodiment 11. The plaster board of any of embodiments 1-10 wherein the hardened plaster material has a first elastic modulus and the viscoelastic interlayer has a second elastic modulus, wherein the second elastic modulus is at least about 0.5% of the first elastic modulus.
   Embodiment 12. The plaster board of any of embodiments 1-11 wherein the plaster board has a total thickness and the viscoelastic interlayer has a thickness at least about 8% of the total thickness.
   Embodiment 13. The plaster board of embodiment 11 wherein the second elastic modulus is at least about 1% of the first elastic modulus.
   Embodiment 14. The plaster board of any of embodiments 1-13 wherein the plaster board has a total thickness and the viscoelastic interlayer has a thickness at least about 16% of the total thickness.
   Embodiment 15. The plaster board of any of embodiments 1-14 wherein the plaster board has a total thickness and the viscoelastic interlayer has a thickness less than about 64% of the total thickness.
   Embodiment 16. The plaster board of any of embodiments 1-15 wherein the score-and-snap element comprises a binder having a reactive all acrylic polymer.
   Embodiment 17. The plaster board of embodiment 16 wherein the binder comprises n-methylolacrylamide (MOA) and acrylamide.
   Embodiment 18. The plaster board of any of embodiments 1-17 wherein the viscoelastic interlayer comprises an ethylene-methacrylic acid copolymer.
   Embodiment 19. The plaster board of any of embodiments 1-18 wherein the hardened plaster material comprises a styrene-acrylic reactive copolymer.
   Embodiment 20. A method of manufacturing a plaster board (e.g., a plaster board according to any of embodiments 1-19), the method comprising:
   applying a first plaster slurry layer to a top surface of a first sheet material;
   applying a damping sheet to a top surface of the first plaster slurry layer;
   applying a second plaster slurry layer to a top surface of the damping sheet; and
   applying a second sheet material to a top surface of the second plaster slurry layer.
   Embodiment 21. The method of embodiment 20 further comprising applying a binder to the damping sheet, wherein the binder is miscible in the first plaster slurry layer.
   Embodiment 22. The method of embodiment 21 wherein the binder comprises a reactive all acrylic polymer.
   Embodiment 23. The method of any of embodiments 20-22 further comprising embossing the top surface of the damping sheet.
   Embodiment 24. The method of any of embodiments 20-23 further comprising embossing the top surface of the first plaster slurry layer.
   Embodiment 25. The method of any of embodiments 20-24 wherein the damping sheet comprises at least one viscoelastic layer and at least one layer of brittle material, wherein the brittle material has an elastic modulus greater than an elastic modulus of the viscoelastic layer.
   Embodiment 26. The method of embodiment 25 wherein the at least one layer of brittle material comprises a glass mat.
   Embodiment 27. The method of any of embodiments 25-26 further comprising embossing a surface of the brittle material layer.
   Embodiment 28. The method of any of embodiments 20-25 wherein applying the damping layer comprises applying a glass mat to the top surface of the first plaster slurry layer and applying a viscoelastic material to the glass mat.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

What is claimed is:

1. A plaster board comprising:
a first layer of hardened plaster material comprising a first surface and an opposed second surface;
a second layer of hardened plaster material comprising a first surface and an opposed second surface, wherein the first surface of the second layer faces the first surface of the first layer;
a viscoelastic interlayer disposed between the first surface of the first layer and the first surface of the second layer, wherein the interlayer includes a score-and-snap element.

2. The plaster board of claim 1 wherein the score-and-snap element comprises at least one of surface having a textured profile, a layer of brittle material, a plurality of pores, or a binder miscible in the hardened plaster material.

3. The plaster board of claim 1, wherein the score-and-snap element comprises a surface having a textured profile.

4. The plaster board of claim 3, wherein the surface having the textured profile is an embossed surface.

5. The plaster board of claim 1 wherein the score-and-snap element comprises a layer of brittle material.

6. The plaster board of claim 5 wherein the layer of brittle material is a glass mat.

7. The plaster board of claim 5 wherein the score-and-snap element comprises a plurality of layers of brittle material.

8. The plaster board of claim 1 wherein the score-and-snap element comprises a plurality of pores.

9. The plaster board of claim 1 wherein the score-and-snap element comprises a binder miscible in the hardened plaster material.

10. The plaster board of claim 1 wherein the viscoelastic interlayer comprises at least one layer of brittle material and at least one layer of viscoelastic material.

11. The plaster board of claim 1 wherein the hardened plaster material has a first elastic modulus and the viscoelastic interlayer has a second elastic modulus, wherein the second elastic modulus is at least about 0.5% of the first elastic modulus.

12. The plaster board of claim 1 wherein the plaster board has a total thickness and the viscoelastic interlayer has a thickness at least about 8% of the total thickness.

13. The plaster board of claim 11 wherein the second elastic modulus is at least about 1% of the first elastic modulus.

14. The plaster board of claim 1 wherein the plaster board has a total thickness and the viscoelastic interlayer has a thickness at least about 16% of the total thickness.

15. The plaster board of claim 1 wherein the plaster board has a total thickness and the viscoelastic interlayer has a thickness less than about 64% of the total thickness.

16. The plaster board of claim 1 wherein the score-and-snap element comprises a binder having a reactive all acrylic polymer.

17. The plaster board of claim 16 wherein the binder comprises n-methylolacrylamide (MOA) and acrylamide.

18. The plaster board of claim 1 wherein the viscoelastic interlayer comprises an ethylene-methacrylic acid copolymer.

19. The plaster board of claim 1 wherein the hardened plaster material comprises a styrene-acrylic reactive copolymer.

20. A method of manufacturing a plaster board according to claim 1, the method comprising:
applying a first plaster slurry layer to a top surface of a first sheet material;
applying a damping sheet to a top surface of the first plaster slurry layer;
applying a second plaster slurry layer to a top surface of the damping sheet; and
applying a second sheet material to a top surface of the second plaster slurry layer.
